(19) United States
(12) Patent Application Publication
(10) Pub. No.: US 2009/0282367 A1
(43) Pub. Date: Nov. 12, 2009

(54) METHOD AND SYSTEM FOR ELECTRONIC COMMUNICATION MANAGEMENT

(75) Inventor: Randy Lawrence Canis, Chesterfield, MO (US)

Correspondence Address: POLSINELLI SHUGHART PC, 700 W. 47TH STREET, SUITE 1000, KANSAS CITY, MO, 64112-1802, US

(73) Assignee: Randy Canis, Chesterfield, MO (US)

(21) Appl. No.: 12/115,640

(22) Filed: May 6, 2008

(51) Int. Cl. G06F 3/048; G06F 15/16; G06F 7/08; G06F 17/30

(52) U.S. Cl. 715/828; 715/835; 709/206; 707/7; 707/E17.009

(57) ABSTRACT

Methods and system for electronic communication management are described. In one embodiment, a plurality of electronic communications for a user may be accessed. User relationship information between the user and at least one additional user may be accessed. User interface data for the plurality of electronic communications may be provided based on the user relationship information.

### BACKGROUND

A user may amass a number of electronic communications from a number of different users. The user may seek to view and/or respond to particular electronic communications.

### BRIEF DESCRIPTION OF THE DRAWINGS

Some embodiments are illustrated by way of example and not limitation in the figures of the accompanying drawings in which:

FIG. 1 is a block diagram of a system, according to an example embodiment;

FIG. 2 is a block diagram of an example interfacing subsystem that may be deployed within the system of FIG. 1 according to an example embodiment;

FIGS. 3-7 are example flowcharts illustrating a method for communication management according to example embodiments; and

FIG. 8 is a block diagram diagrammatic representation of machine in the example form of a computer system within which a set of instructions for causing the machine to perform any one or more of the methodologies discussed herein may be executed.

### DETAILED DESCRIPTION

Example methods and systems for electronic communication management are described. In the following description, for purposes of explanation, numerous specific details are set forth in order to provide a thorough understanding of example embodiments. It will be evident, however, to one skilled in the art that embodiments of the present invention may be practiced without these specific details.

In an example embodiment, a plurality of electronic communications for a user may be accessed. User relationship information between the user and at least one additional user may be accessed. User interface data for the plurality of electronic communications may be provided based on the user relationship information.

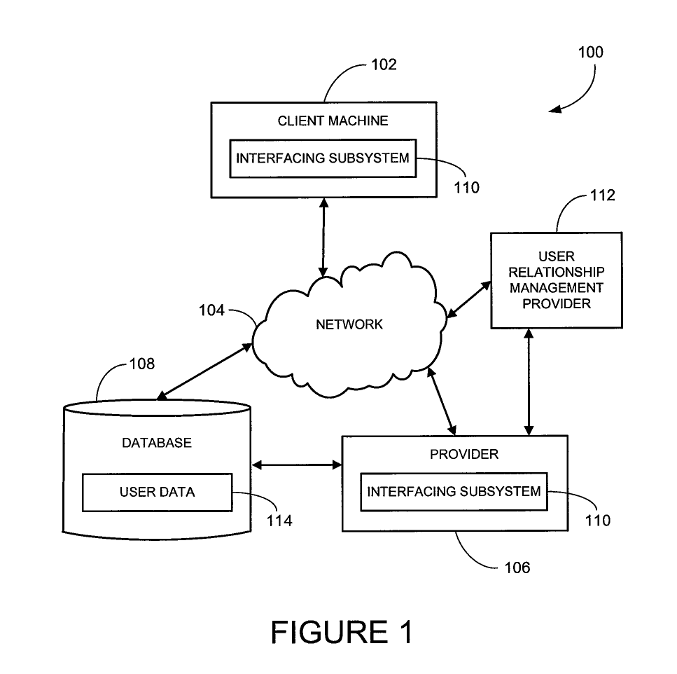

FIG. 1 illustrates an example system 100 in which a client machine 102 may be in communication with a provider 106 over a network 104. A user may operate the client machine 102 to send and/or receive electronic communications from one or more additional users. Examples of the client machine 102 include a set-top box (STB), a receiver card, a mobile telephone, a personal digital assistant (PDA), a display device, a portable gaming unit, and a computing system; however other devices may also be used.

The network 104 over which the client machine 102 and the provider 106 are in communication may include a Global System for Mobile Communications (GSM) network, an Internet Protocol (IP) network, a Wireless Application Protocol (WAP) network, a WiFi network, or a IEEE 802.11 standards network as well as various combinations thereof. Other conventional and/or later developed wired and wireless networks may also be used.

The provider 106 may manage the electronic communications on behalf of a user. The provider 106 may also manage the electronic communications of one or more additional users. However, other providers not associated with the user of the client machine 102 may manage electronic communications of additional users. Examples of providers 106 include MICROSOFT, YAHOO, and GOOGLE.

An interfacing subsystem 110 may be deployed within the client machine 102 and/or the provider 106 to enable providing of user interface data for the electronic communications of the user. The interfacing subsystem 110 may be used to provide user interface data based on user relationship information.

The provider 106 may also be in communication with a database 108. The database 108 may include user data 114 include information regarding users of the provider 106. The user data 114 may include user relationship information and/or other types of user information.

In an example embodiment, the user relationship information may identify a number of degrees of separation between a user of the client machine 102 one or more additional users. For example, the user and the additional user may be friends having a first degree of separation or the user and the additional user may be friends of a friend having a second degree of separation.

In an example embodiment, the user relationship information may identify whether the user and one or more additional users are in a social networking relationship with one another. For example, a user and an additional user may be a member of a same social networking group (e.g., South Africans living in St. Louis).

The user relationship management provider 112 may include user relationship information regarding the user and one or more additional users. Examples of user relationship management providers 112 include FaceBook.com by Facebook, Inc, LinkedIn.com by LinkedIn Corporation, and MySpace.com by MySpace, Inc.

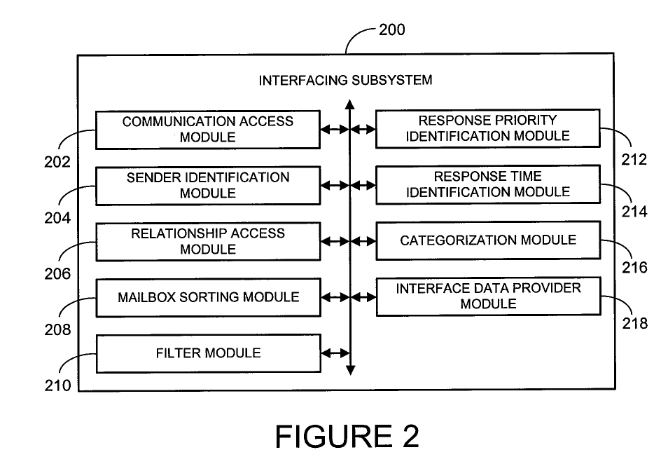

FIG. 2 illustrates an example interfacing subsystem 200 that may be deployed in the client machine 102 and/or the provider 106 of the system 100 (see FIG. 1) or otherwise deployed in another system. The interfacing subsystem 200 may include a communication access module 202, a sender identification module 204, a relationship access module 206, a mailbox sorting module 208, a filter module 210, a response priority identification module 212, a response time identification module 214, a categorization module 216, and/or a interface data provider module 218. Other modules may also be included.

The communication access module 202 accesses a number of electronic communications for a user. The electronic messages may mail messages, instant messages, electronic facsimiles, or the like. The sender identification module 204 identifies a sender of one or more electronic communications.

The relationship access module 206 accesses user relationship information between the user and one or more additional users. In an example embodiment, the relationship access module 206 may provide a relationship request to the user relationship management provider 112 and receive the user relationship information from the user relationship management provider 112. The accessing of the user relationship information may be based on identification of the sender.

The mailbox sorting module 208 sorts a mailbox containing the electronic communications based on the accessing of the user relationship information. The filter module 210 filters the electronic communications based on the user relationship information.

The response priority identification module 212 identifies a response priority for the electronic communications based on the user relationship information. The response time identification module 214 identifies a response time for the electronic communications based on the user relationship information. The categorization module 216 categorizes multiple additional users into one or more categories based on the user relationship information.

The interface data provider module 218 provides user interface data for the electronic communications based on the user relationship information. The user interface data may be provided through an application programming interface (API) or may be otherwise provided. The providing of the user interface data may include providing a user interface to the electronic communications based on the user relationship information. The providing of the user interface data may be based on the sorting of the mailbox, filtering of the electronic communications, identification of the response priority, identification of the response time, and/or categorization of multiple users. The user interface data may be otherwise provided.

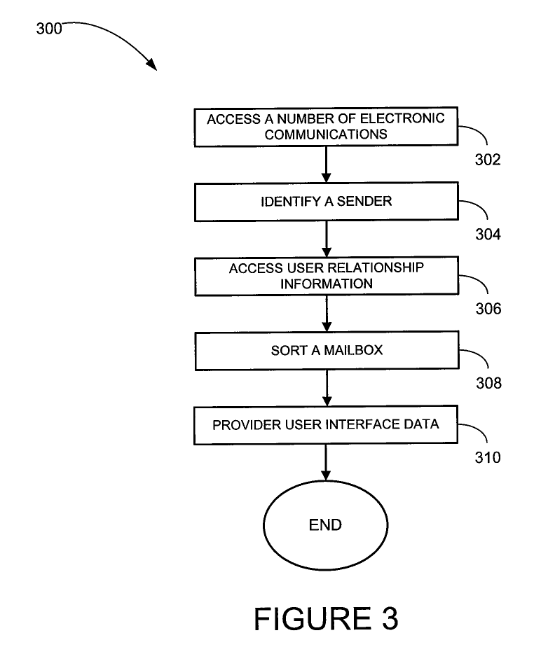

FIG. 3 illustrates a method 300 for communication management according to an example embodiment. The method 300 may be performed by the client machine 102 and/or the provider 106 of the system 100 (see FIG. 1) or otherwise performed.

A number of electronic communications for a user is accessed at block 302. The electronic messages may include, by way of example, mail messages, instant messages, electronic facsimiles, or the like. A sender of at least one electronic communication of the electronic communications may be identified at block 304.

User relationship information between the user and at least one additional user is accessed at block 306. The accessing of the user relationship information may be based on identification of the sender. In an example embodiment, the user relationship information may be accessed by providing a relationship request to the user relationship management provider 112 and receiving user relationship information from the user relationship management provider 112.

In an example embodiment, the user relationship information may identify a number of degrees of separation between the user and a particular user of the at least one additional user. In an example embodiment, the user relationship information may identify whether the user and a particular user of the at least one additional user are in a social networking relationship with one another.

A mailbox containing the electronic communications may be sorted based on the accessing of the user relationship information at block 308. For example, users having a particular type of user relationship information (e.g., membership in a first group type of a social network) may be sorted into a first group, users having a different type of user relationship information (e.g., membership in a second group type of a same social network) may be sorted into a second group, and so on.

At block 310, the user interface data is provided for the electronic communications based on the user relationship information and/or the sorting of the mailbox. The user interface data may be provided through an application programming interface (API) or may otherwise be provided. The providing of the user interface data may include providing a user interface to the electronic communications based on the user relationship information.

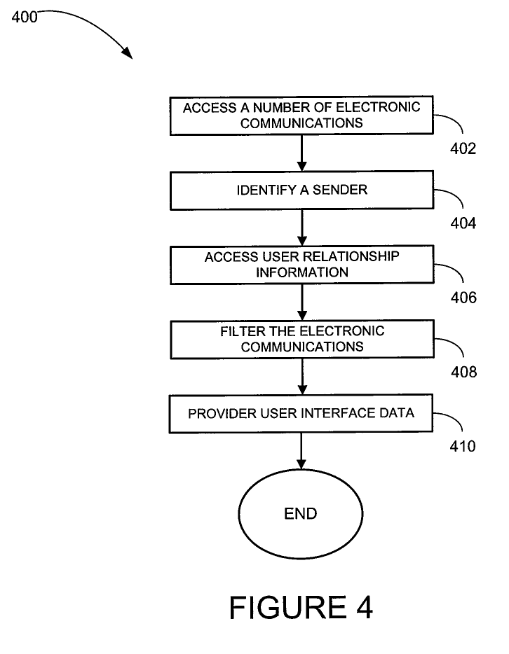

FIG. 4 illustrates a method 400 for communication management according to an example embodiment. The method 400 may be performed by the client machine 102 and/or the provider 106 of the system 100 (see FIG. 1) or otherwise performed.

A number of electronic communications for a user is accessed at block 402. A sender of at least one electronic communication of the electronic communications may be identified at block 404. User relationship information between the user and at least one additional user is accessed at block 406.

The electronic communications may be filtered based on the user relationship information at block 408. For example, the additional users that are not members in a particular group of a social network may be filtered so as to not be identified within the user interface data.

At block 410, the user interface data is provided for the electronic communications based on the user relationship information and/or the filtering of the electronic communications.

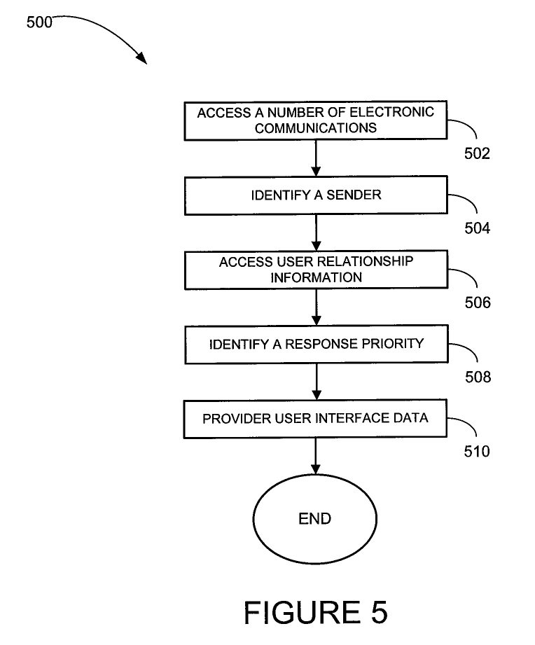

FIG. 5 illustrates a method 500 for communication management according to an example embodiment. The method 500 may be performed by the client machine 102 and/or the provider 106 of the system 100 (see FIG. 1) or otherwise performed.

A number of electronic communications for a user is accessed at block 502. A sender of at least one electronic communication of the electronic communications may be identified at block 504. User relationship information between the user and at least one additional user is accessed at block 506.

In an example embodiment, the user relationship information may be accessed by providing a relationship request to a user relationship management provider and receiving user relationship information between the user and the at least one additional user from the user relationship management provider.

A response priority for the electronic communications may be identified based on the user relationship information at block 508. The response priority may provide an indication of a response importance in a user interface provided to the user. For example, additional users that are known in a first degree in a social network may be indicated as having a first response priority (e.g., high priority) and additional users that are known in a second degree in the same social network may be indicated as having a second response priority (e.g., normal priority).

At block 510, the user interface data is provided for the electronic communications based on the user relationship information and/or the response priority.

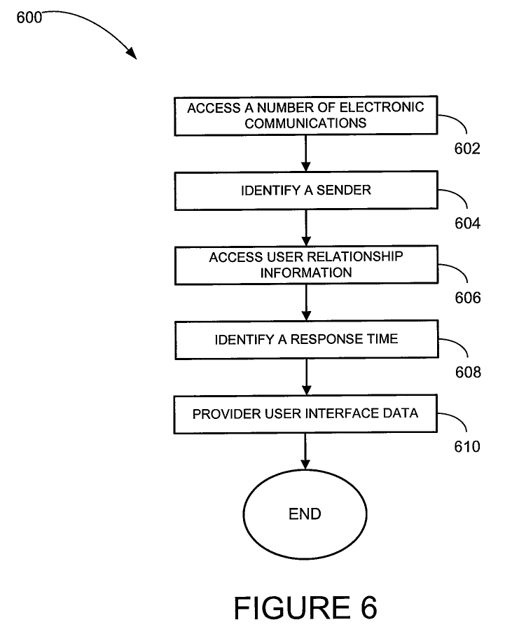

FIG. 6 illustrates a method 600 for communication management according to an example embodiment. The method 600 may be performed by the client machine 102 and/or the provider 106 of the system 100 (see FIG. 1) or otherwise performed.

A number of electronic communications for a user is accessed at block 602. A sender of at least one electronic communication of the electronic communications may be identified at block 604. User relationship information between the user and at least one additional user is accessed at block 606.

A response time may be identified for the electronic communications based on the user relationship information at block 608. The response priority may, in an example embodiment identify an acceptable period of time to respond a particular electronic communication. For example, additional users that are known in a first degree in a social network may have a first response time and additional users that are known in a second degree in the same social network may have a second response time.

At block 610, the user interface data is provided for the electronic communications based on the user relationship information and/or the response time.

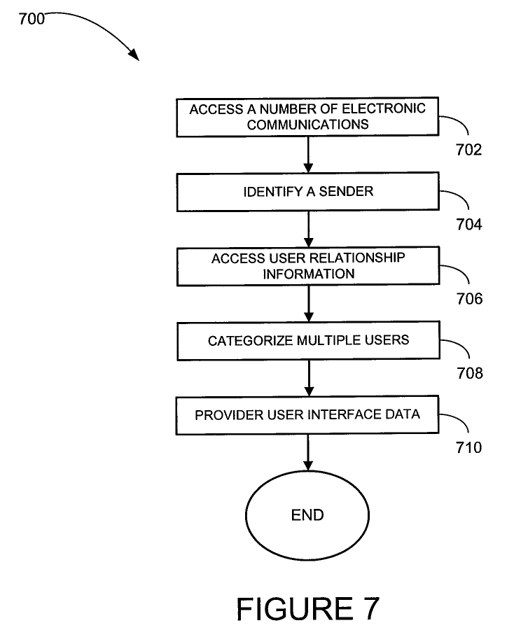

FIG. 7 illustrates a method 700 for communication management according to an example embodiment. The method 700 may be performed by the client machine 102 and/or the provider 106 of the system 100 (see FIG. 1) or otherwise performed.

A number of electronic communications for a user is accessed at block 702. A sender of at least one electronic communication of the electronic communications may be identified at block 704. User relationship information between the user and multiple additional users is accessed at block 706. In an example embodiment, the user relationship information may identify a number of degrees of separation between the user and the multiple additional users. In an example embodiment, the user relationship information may identify whether the user and a particular user of the multiple additional users are in a social networking relationship with one another. The accessing of the user relationship information may be based on identification of the sender.

In an example embodiment, the user relationship information may be accessed by providing a relationship request to the user relationship management provider 112 and receiving user relationship information from the user relationship management provider 112.

The multiple additional users may be categorized into one or more categories based on the user relationship information at block 708. For example, friends of friends may be categorized at a lower level then friends. Business colleagues may be categorized at a higher level than non-business colleagues.

At block 710, the user interface data is provided for the electronic communications based on the user relationship information and/or the categorization of the multiple additional users.

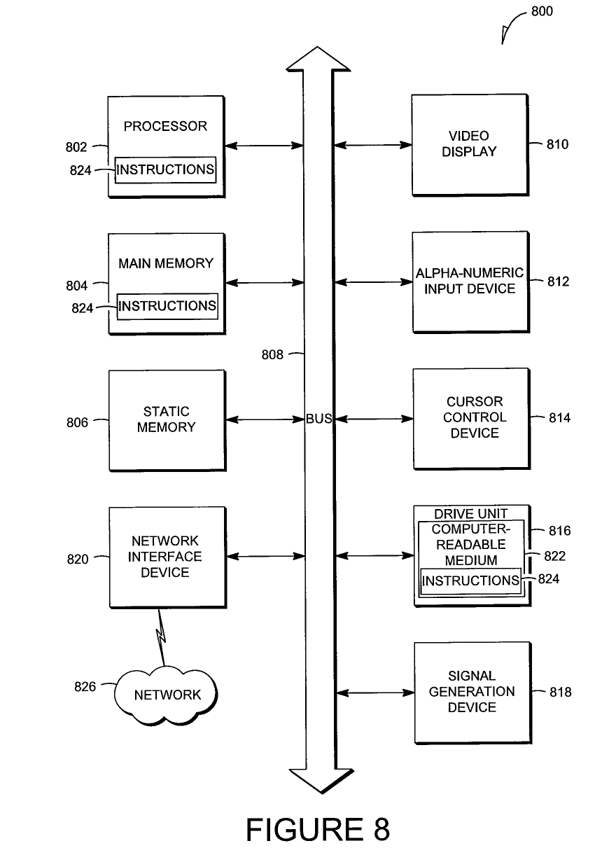

FIG. 8 shows a diagrammatic representation of machine in the example form of a computer system 800 within which a set of instructions may be executed causing the machine to perform any one or more of the methods, processes, operations, or methodologies discussed herein. The provider 106 and/or the user relationship management provider 112 may operate on or more computer systems 800. The client machine 102 may include the functionality of one or more computer systems 800.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU) a graphics processing unit (GPU) or both), a main memory 804 and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard), a cursor control device 814 (e.g., a mouse), a drive unit 816, a signal generation device 818 (e.g., a speaker) and a network interface device 820.

The drive unit 816 includes a machine-readable medium 822 on which is stored one or more sets of instructions (e.g., software 824) embodying any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 826 via the network interface device 820.

While the machine-readable medium 822 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the embodiments of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for electronic communication management have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
accessing a plurality of electronic communications for a user;
accessing user relationship information between the user and at least one additional user; and
providing user interface data for the plurality of electronic communications based on the user relationship information.

2. The method of claim 1, further comprising:
identifying a sender of at least one electronic communication of the plurality of electronic communications,
wherein the accessing user relationship information is based on the identifying of the sender.

3. The method of claim 1, wherein the accessing of the user relationship information comprises:
receiving user relationship information between the user and the at least one additional user from a user relationship management provider.

4. The method of claim 3, further comprising:
providing a relationship request to a user relationship management provider,
wherein the receiving of the user relationship information is based on the providing of the relationship request.

5. The method of claim 1, wherein the providing of the user interface data comprises:
providing the user interface data for the plurality of electronic communications based on the user relationship information through an application programming interface (API).

6. The method of claim 1, wherein the providing of the user interface data comprises:
providing a user interface to the plurality of electronic communications based on the user relationship information.

7. The method of claim 1, further comprising:
sorting a mailbox containing the plurality of electronic communications based on the accessing of the user relationship information,
wherein the providing the user interface data is based on the sorting of the mailbox.

8. The method of claim 1, further comprising:
filtering the plurality of electronic communications based on the user relationship information,
wherein the providing of the user interface data is based on the filtering of the plurality of electronic communications.

9. The method of claim 1, wherein the presenting of the user interface comprises:
identifying a response priority for the plurality of electronic communications based on the user relationship information,
wherein the providing the user interface data is based on the identifying of the response priority.

10. The method of claim 1, wherein the presenting of the user interface comprises:
identifying a response time for the plurality of electronic communications based on the user relationship information,
wherein the providing the user interface data is based on the identifying of the response time.

11. The method of claim 1 wherein the at least one additional user includes a plurality of users, further comprising:
categorizing the plurality of users into one or more categories based on the user relationship information,
wherein the providing the user interface data is based on the categorizing of the plurality of users.

12. The method of claim 1, where the user relationship information identifies a number of degrees of separation between the user and a particular user of the at least one additional user.

13. The method of claim 1, where the user relationship information identifies whether the user and a particular user of the at least one additional user are in a social networking relationship with one another.

14. The method of claim 1, wherein the electronic messages include at least one of a mail message, an instant message, an electronic facsimile, or combinations thereof.

15. A machine-readable medium comprising instructions, which when implemented by one or more processors perform the following operations:
access a plurality of electronic communications for a user;
access user relationship information between the user and at least one additional user; and
provide user interface data for the plurality of electronic communications based on the user relationship information.

16. The machine-readable medium of claim 15 further comprising instructions, which when implemented by one or more processors perform the following operations:
identify a response priority for the plurality of electronic communications based on the user relationship information,
wherein providing the user interface data is based on identification of the response priority.

17. A system comprising:
a communication access module to access a plurality of electronic communications for a user;
a relationship access module to access user relationship information between the user and at least one additional user; and
an interface data provider module to provide user interface data for the plurality of electronic communications accessed by the communication access module based on the user relationship information accessed by the relationship access module.

18. The system of claim 17, further comprising:
a mailbox sorting module to sort a mailbox containing the plurality of electronic communications based on the accessing of the user relationship information by the communication access module,
wherein providing of the user interface data by the interface data provider module is based on the sorting of the mailbox by the mailbox sorting module.

19. The system of claim 17, further comprising:
a filter module to filter the plurality of electronic communications based on the user relationship information,
wherein providing of the user interface data by the interface data provider module is based on the filtering of the plurality of electronic communications by the filter module.

20. The system of claim 17, wherein the at least one additional user includes a plurality of additional users, further comprising
a categorization module to categorize the plurality of additional users into one or more categories based on the user relationship information,
wherein providing the user interface data by the interface data provider module is based on the categorizing of the plurality of additional users by the categorization module.
